(19) United States
(12) Patent Application Publication
(10) Pub. No.: US 2006/0009367 A1
(43) Pub. Date: Jan. 12, 2006

(54) Liquid bleaching compositions

(75) Inventors: Leo Gagliardi, Saracena (C.S.) (IT); Carlo Ricci, Rome (IT); Luca Sarcinelli, Palermo (IT)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/174,888

(22) Filed: Jul. 5, 2005

(30) Foreign Application Priority Data
Jul. 12, 2004 (EP) 04447171.2

(51) Int. Cl. C11D 3/00

(52) U.S. Cl. 510/302

(57) ABSTRACT

The present invention relates to a liquid bleaching composition, having a pH up to 3, and compromises an imido-type peroxy acid and a succinoglycan gum.

### FIELD OF THE INVENTION

The present invention relates to a liquid bleaching composition which can be used to bleach various surfaces including but not limited to, hard-surfaces as well as fabrics, clothes, carpets and the like. In particular, the present invention relates to a bleach additive composition, which can be used to bleach fabrics in conjunction with a conventional particulate or liquid laundry detergent as well as laundry detergent forms based on water-soluble or water-permeable pouches comprising liquids and/or particulates (such as liquid-tabs).

### BACKGROUND OF THE INVENTION

Commonly encountered liquid bleaching compositions suitable for the bleaching of stains on fabrics are based on halogen bleaches, especially hypochlorite bleaches, or peroxygen oxygen bleaches such as hydrogen peroxide.

Halogen bleaches are extremely effective bleaching agents, however they also present a number of drawbacks which can sometimes dissuade a consumer from choosing the halogen-containing product. For example, halogen bleaches, especially chlorine bleaches, emit a pungent odor during and after use (e.g., on consumer hands and/or surfaces treated therewith) which some consumer find disagreeable.

Furthermore, it is known in the art that halogen bleach-containing compositions (typically hypochlorite) are relatively aggressive to fabrics and may cause damage when used in relatively high concentration and/or repeated usage. In particular, the consumer may perceive damage to the fabric itself (e.g. loss of tensile strength) or damage to the color intensity of the fabric. While color and fabric damage may be minimized by employing milder peroxygen bleaches such as hydrogen peroxide, the bleach performance characteristics of such peroxygen bleaches are much less desirable than those of the halogen bleaching agents.

Therefore, liquid bleaching compositions comprising pre-formed peroxy carboxylic acid have been developed. It has been found that such bleaching compositions comprising pre-formed peroxy carboxylic acid show a good bleaching performance, when used in laundry applications, especially as so-called bleach additives, and are also safe to fabrics and/or colors. Indeed, peroxy carboxylic acids are known in the art, e.g., from EP-A-0 435 379. Furthermore, the use of such peroxy carboxylic acid to treat fabrics has been described in the art, e.g., in WO 00/27963, WO 00/27964, WO 00/27965, WO 00/27966, WO 00/27967, WO 00/27977 and WO 2002/12431.

It has been found that the chemical stability of currently known peroxy carboxylic acid-based bleach additives was below expectations. In addition, preformed peroxy carboxylic acids represent a challenge to be handled at bleach additives manufacturing plants.

These difficulties have recently been overcome with the use of imido-type peroxy acids, which being solids, are safer to be handled at manufacturing plants, and can also be chemically stabilized into liquid bleach additive formulations by suspending them as solid particles. A specific class of imido-type peroxy acids are imido-type peroxy alkanoic acids, especially phthalimido peroxy alkanoic acids, and in particular ε-phthalimido peroxy hexanoic acid (PAP).

However, given their chemical structure, imido-type peroxy acids when present in bleach additives are difficult to physically stabilize. Indeed, such imido-type peroxy acids-containing liquid compositions have a tendency to physical instability, which is manifested as imido-type peroxy acid particles settling, wherein particles of the substantially water insoluble, pre-formed imido-type peroxy acid separate from the aqueous phase, upon (prolonged periods of) storage. Therefore, bleaching compositions comprising a solid, substantially water insoluble pre-formed, imido-type peroxy acid and a polymeric system, comprising a gum-type polymer, such as Xanthan gum, and a cross-linked polycarboxylate polymer were proposed (see WO00/27979).

It has now been found that even though such bleaching compositions comprising a solid, substantially water insoluble pre-formed, imido-type peroxy acid and a polymeric system, comprising a gum-type polymer and a cross-linked polycarboxylate polymer are physically and chemically stable under normal conditions, the physical stability (phase stability), of imido-type peroxy acids-containing liquid compositions having a pH below 3 can still be further improved. Indeed, at lower pH (i.e., pH below 3), which is below the pKa of such cross-linked polycarboxylate polymer, the cross-linked polycarboxylate polymers are protonated and fail to provide any suitable thickening and/or structuring activity. Furthermore, despite the presence of Xanthan gum, imido-type peroxy acids-containing liquid compositions having a pH up to 3 are physically not stable, in particular upon prolonged periods of storage, and show a settling of imido-type peroxy acid particles upon storage.

It is thus an objective of the present invention to provide a liquid bleaching composition comprising an imido-type peroxy acid, wherein the composition has a pH below about 3 that does not show a settling of imido-type peroxy acid particles, i.e., it is physically stable.

It has now been found that a liquid bleaching composition, having a pH below about 3, and comprising an imido-type peroxy acid and a succinoglycan gum meets the above objective.

An advantage of the compositions of the present invention is that the compositions are physically stable upon prolonged periods of storage at room temperature (such as up to about 360 days).

A further advantage of the liquid bleaching compositions herein is that they are suitable for the bleaching of different types of fabrics including natural fabrics, (e.g., fabrics made of cotton, and linen), synthetic fabrics such as those made of polymeric fibres of synthetic origin (e.g., polyamide-elasthane) as well as those made of both natural and synthetic fibres. For example, the liquid bleaching compositions of the present invention herein may be used on synthetic fabrics despite a standing prejudice against using bleaches on synthetic fabrics, as evidenced by warnings on labels of clothes and commercially available bleaching compositions like hypochlorite-containing compositions.

Another advantage of the liquid bleaching compositions herein is that they can be used in a variety of conditions, i.e., in hard and soft water.

Yet another advantage of the compositions of the present invention is that they exhibit also effective stain removal performance on various stains including enzymatic stains and/or greasy stains.

### SUMMARY OF THE INVENTION

The present invention encompasses a liquid bleaching composition, having a pH up to about 3, and compromising an imido-type peroxy acid and a succinoglycan gum.

The present invention further encompasses the use of a succinoglycan gum in a liquid bleaching compositions, having a pH up to about 3, and compromises an imido-type peroxy acid, whereby an immediate physical stability benefit and/or a physical stability upon storage benefit is provided.

The present invention further encompasses a process of bleaching a surface, preferably a fabric, with the liquid bleaching composition herein.

Furthermore, the present invention encompasses a process of treating fabrics which comprises the steps of forming an aqueous bath comprising water, a conventional laundry detergent, preferably a particulate laundry detergent, and a liquid bleaching composition according to the present invention, and subsequently contacting said fabrics with said aqueous bath.

### DETAILED DESCRIPTION OF THE INVENTION

The Liquid Bleaching Composition

The liquid bleaching compositions herein have pH of up to about 3. Preferably, the liquid bleaching compositions herein have a pH between about 0.5 and about 3, preferably about 1.5 and about 2.5 and most preferably about 1.8 and about 2.5.

The compositions herein may comprise an acid (i.e., a source of protons, as described herein below). Furthermore, even though it is not preferred herein, the compositions herein may comprise an alkaline material. Examples of alkaline material are sodium hydroxide, potassium hydroxide and/or sodium carbonate.

As detailed herein below, the presence a source of protons, if any, in the liquid bleaching compositions herein may contribute to the bleaching performance of the liquid bleaching compositions herein, especially in a through-the-wash bleach operation. Furthermore, formulating the compositions according to the present invention in the acidic pH range contributes to the chemical stability of the additive compositions according to the present invention. The pH of the composition is preferably below the pKa of acid corresponding to the imido-type peroxy acid used. It is believed that the acidic pH controls/limits the formation of highly reactive species which are instable in acidic medium upon storage, and thus contributes to the stability of the compositions for prolonged periods of storage.

The compositions according to the present invention are liquid compositions as opposed to a solid or a gas.

Preferably, the liquid bleach additive compositions have a viscosity of up to about 5000 cps at 20 s⁻¹, more preferably from about 5000 cps to about 50 cps, yet more preferably from about 2000 cps to about 50 cps and most preferably from about 1200 cps to about 50 cps at 20 s⁻¹ and 20° C. when measured with a Carri-Med Rheometer model CSL² 100® (Supplied by TA Instruments) with a 4 cm conic spindle in stainless steal (linear increment from 0.1 to 100 sec⁻¹ in max. 8 minutes). In an alternative embodiment, the liquid bleaching compositions are preferably pasty or paste-like compositions.

Furthermore, the liquid bleaching compositions herein are preferably aqueous compositions and may comprise at least about 50%, preferably from about 50% to about 95%, more preferably about 70% to about 95%, even more preferably about 75% to about 95% by weight of the total composition of water.

Imido-Type Peroxy Acids

The bleaching composition of the present invention comprises an imido-type peroxy acid. Said imido-type peroxy acid is preferably a solid, pre-formed imido-type peroxy acid. More preferably, said imido-type peroxy acid is a solid, substantially water insoluble (even more preferably solid, water insoluble) pre-formed imido-type peroxy acid. By “substantially water-insoluble” it is meant herein a solubility in water that is insignificant (such as below about 1 g/lt, preferably below 0.6 g/lt., of demineralized water at 25° C.). In a preferred embodiment of the present invention the imido-type peroxy acid has the general formula:
X—R—C(O)OOH
wherein R is a linear or branched, substituted or unsubstituted hydrocarbon chain having at least about 1 carbon atom and X is a substituted imide, preferably a substituted imide wherein the imidic nitrogen forms a bond with R.

By a “substituted imide” it is meant herein an imide having a substitution on the nitrogen.

Preferably the imido-type peroxy acid is according to the general formula: 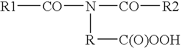
wherein R1 and R2 are independently linear or branched, substituted or unsubstituted hydrocarbon chains having at least about 1 carbon atom, preferably aliphatic or aromatic hydrocarbon chains and may form a ring.

More particularly the R group preferably comprises from about 2 to about 24 carbon atoms. Alternatively, the R group may be a branched alkyl chain comprising one or more side chains which comprise substituent groups selected from the group consisting of aryl, halogen, ester, ether, amine, amide, substituted phthalic amino, imide, hydroxide, sulphide, sulphate, sulphonate, carboxylic, heterocyclic, nitrate, aldehyde, ketone or mixtures thereof.

In a preferred peracid the X group, according to the above general formula, is a phthalimido group. Thus, particularly preferred imido-type peroxy acids herein are those having general formula: 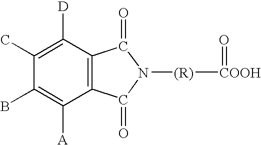
where R is about C1-20 alkyl group and where A, B, C and D are independently either hydrogen or substituent groups individually selected from the group consisting of alkyl, hydroxyl, nitro, halogen, amine, ammonium, cyanide, carboxylic, sulphate, sulphonate, aldehydes or mixtures thereof.

In a preferred aspect of the present invention R is an alkyl group having from about 3 to about 12 carbon atoms, more preferably from about 5 to about 9 carbon atoms. Preferred substituent groups A, B, C and D are linear or branched alkyl groups having from about 1 to about 5 carbon atoms, but more preferably hydrogen.

In a preferred embodiment herein, said imido-type peroxy acid is an imido-type peroxy alkanoic acid, preferably a phthalimido peroxy alkanoic acid, even more preferably said imido-type peroxy acid is selected from the group consisting of: ε-phthalimido peroxy hexanoic acid (also known as Phthalimido peroxy caproic acid—PAP); phthalimido peroxy heptanoic acid; phthalimido peroxy octanoic acid; phthalimido peroxy nonanoic acid; and Phthalimido peroxy decanoic acid; and mixtures thereof and most preferably ε-phthalimido peroxy hexanoic acid (PAP).

Suitable phthalimido peroxy alkanoic acids have the general formula: 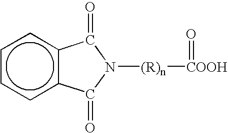
wherein R is selected from about C1-4 alkyl and n is an integer of from about 1 to about 5.

PAP (ε-phthalimido peroxy hexanoic acid) as mentioned above is according to the above formula wherein R is CH₂ and n is about 5.

PAP is preferably used as a substantially water-insoluble solid or wet-cake and is available from Ausimont under the trade name Eureco®.

Said imido-type peroxy acid may be present at a level in the composition of from about 0.1% to about 10% more preferably about 0.1% to about 5% and most preferably about 1% to about 5% by weight of the total composition. Alternatively the peracid may be present at a much higher level of for example about 10% to about 40%, more preferably from about 15% to about 30%, most preferably from about 20% to about 25% by weight of the total composition.

Succinoglycan Gum

The liquid bleaching composition of the present invention comprises a succinoglycan gum.

Succinoglycan gums are heteropolysaccharides synthesized by a variety of bacteria belonging to the family Rhizobiaceae (Rhizobium, Agrobacterium), as well as by other microorganisms like Alcaligenes faecalis variety myxogenes and Pseudomonas species. Succinoglycan gums are acidic polysaccharides composed of octasaccharide repeating units in which galactose and glucose monomers occur in a molar ratio of about 1 to about 7. Succinate and pyruvate are commonly found as non-saccharidic substituents, whereas acetate might or might not be present, depending on the source of the polymer.

A suitable succinoglycan gum is commercially available under the trade-name RHEOZAN® from RHODIA.

The liquid bleaching composition of the present invention preferably comprises of from about 0.01% to about 10%, more preferably from about 0.05% to about 3%, even more preferably from, about 0.1% to about 1% and most preferably from about 0.15% to about 0.6% by weight of the total composition of said succinoglycan gum.

The liquid bleaching composition herein is preferably free of cross-linked polycarboxylate polymers. Indeed, it has been found that cross-linked polycarboxylate polymers have no thickening and/or structuring activity at pH about 3 or below.

It has now been found that the presence of succinoglycan gum in liquid bleaching compositions, having pH of up to about 3, and comprising an imido-type peroxy acid, not only physically stabilizes said bleaching compositions immediately after the manufacture of said bleaching composition (“immediate physical stability benefit”) but also physically stabilizes said liquid bleaching composition upon storage (“physical stability upon storage benefit”). Indeed, it has been found that other gum-type polymers, such as Xanthan gum, fail provide physically stable liquid bleaching compositions having pH of up to about 3, and comprising an imido-type peroxy acid. This is due both to the higher pKa of Xanthan gum carboxylic groups, which get protonated at pH about 3 or below, as well as to the lower rigidity and interchain association as compared to succinoglycan gum.

By “physical stability” it is meant herein that the liquid bleaching composition show a homogeneous distribution of solid imido-type peroxy acid in the liquid bulk phase, wherein the solid imido-type peroxy acid is suspended in. Indeed, no settling of solid imido-type peroxy acid particles is detected.

By “immediate physical stability” it is meant herein, that in the liquid bleaching compositions the solid imido-type peroxy acid remains homogeneously suspended in the liquid bulk phase immediately after the manufacture of said liquid bleaching composition. By “physical stability upon storage” it is meant herein, that in the liquid bleaching compositions the solid imido-type peroxy acid remains homogeneously suspended in the liquid bulk phase over a period of storage of about 3 months at about 25 C. Thus, in practice this means that a bleaching composition remains sufficiently physically stable throughout the use by the consumer.

Generally, the immediate physical stability and physical stability upon storage of the in a bleaching composition may be evaluated by assessing the homogeneous or non-homogenous distribution of solid imido-type peroxy acid particles either: visually (by detecting the solid imido-type peroxy acid particles); or by titrating peracid concentration at different heights of samples under testing; wherein for both test methods mixing of the samples upon storage has to be avoided.

Test Method for Physical Stability Upon Storage

The physical stability upon storage of the compositions according to the present invention may alternatively be assessed in the laboratory using a rapid ageing test (“RAT”). The RAT involves assessing the homogeneous distribution (as described above) of solid imido-type peroxy acid particles in a fresh liquid bleaching composition just after it is made and of the same composition after 7 days at 50° C. and/or 8 weeks at 35° C. Under laboratory conditions, by “physical stable upon storage”, it is therefore to be understood that the compositions of the present invention typically do not undergo a phase-split at 50° C.±0.5° C. after 7 days and/or after 8 weeks at 35° C.

Optional Ingredients

The compositions herein may further comprise a variety of other optional ingredients such as polymeric systems, surfactants, chelating agents, radical scavengers, antioxidants, stabilisers, builders, soil suspending polymer, brighteners, perfumes, pigments, dyes and the like.

In a preferred embodiment of the present invention the composition herein is free of hydrophobically modified polycarboxylate polymers and/or nonionic surfactants. Indeed, hydrophobically modified polycarboxylates can be used at pH below about 3 to provide thickening and/or structuring activity, but they require the presence of nonionic surfactants to associate with. However, the combination of hydrophobically modified polycarboxylates and nonionic surfactants is not ideal for imido-type peroxy acids-containing liquid compositions, as the nonionic surfactant may negatively impact the stability of the imido-type peroxy acid.

Source of Protons

As an optional but highly preferred ingredient the compositions herein may comprise a source of protons. The source of protons, if present, may contribute to the ionic strength of the liquid bleaching compositions herein.

By a “source of protons” it is meant herein a species with Lewis/Bronsted acid behavior, i.e., a species which in water solution is capable of donating a proton or accepting an electron pair from another species.

The liquid bleaching composition herein may contain any kind of source of protons. Indeed, suitable for use herein are organic acids, such as citric acid and inorganic acids, such as sulphuric acid, sulphonic acid and/or metanesulphonic acid.

It has been found that by adding a sufficient amounts of sources of protons (i.e., reserve acidity) into an imido-type peroxy acid-based bleaching composition, the bleaching performance of the composition, especially in a through-the-wash bleach operation, is significantly increased in comparison to bleaching compositions containing no or too little amounts of sources of protons (i.e., reserve acidity) used in a similar operation. This effect is further described in the Applicant's co-pending European Patent Application EP2004447089.6 (incorporated herein by reference)/

Preferably the source of protons has at least one acidic moiety donating protons in water at a pH below about 7.5, wherein said composition comprises at least about 0.80 mmoles of protons available at pH below about 7.5 per gram of composition. The compositions herein may comprise a mixture of suitable sources of protons.

By “mmoles of protons available at pH below about 7.5 per gram of composition” it is meant herein the concentration of protons (in mmoles per gram of composition) available, this means either free protons or protons that may disassociate, at a pH below about 7.5, which are capable of being delivered to (alkaline/base) species present in the wash solution and thereby reducing the pH in the wash liquor/solution formed by a conventional laundry detergent, preferably a conventional particulate laundry detergent.

The concentration (in mmoles per gram of composition) of available protons in a given composition is equivalent to the amount in mmoles of 1 M Sodium Hydroxide solution (1 mol of NaOH in 1 liter of demin. water) needed to bring the pH of 100 grams of the given composition up to a value of 7.5 and divided by 100.

For example, for 100 grams of a composition consisting of about 5 grams citric acid and about 95 grams of water (citric acid has mol. wt. of 192.12 and three acidic protons donated at a pH below about 7.5), about 79 mmoles of 1 M Sodium Hydroxide solution are required to bring the pH up to a value of about 7.5. This means that said composition comprise a source of protons donating protons in water at a pH below about 7.5 and wherein said source of protons is present at a concentration of about 0.79 mmoles of protons available at pH below about 7.5 per gram of composition.

Alternatively, for about 100 grams of a composition consisting of about 5 grams succinic acid and 9 about 5 grams of water (succinic acid has mol. wt. of 118.09 and two acidic protons donated at a pH below 7.5), about 85 mmoles of 1 M Sodium Hydroxide solution are required to bring the pH up to a value of about 7.5. This means that said composition comprise a source of protons donating protons in water at a pH below about 7.5 and wherein said source of protons is present at a concentration of about 0.85 mmoles of protons available at pH below about 7.5 per gram of composition.

Furthermore, for about 100 grams of a composition consisting of about 4 grams succinic acid, about 4 grams of citric acid and about 92 grams of water, about 130 mmoles of 1 M Sodium Hydroxide solution are required to bring the pH up to a value of 7.5. This means that said composition comprise a source of protons donating protons in water at a pH below about 7.5 and wherein said source of protons is present at a concentration of about 1.30 mmoles of protons available at pH below about 7.5 per gram of composition.

The source of protons herein preferably is present at a concentration of at least about 0.80, preferably at least about 0.90, more preferably about 1.0, even more preferably about 1.1, yet more preferably about 1.8, still more preferably about 2.0 and most preferably about 2.5 mmoles of protons available at pH below about 7.5 per gram of composition.

In a preferred embodiment herein, the source of protons herein may be present at a concentration of up to about 5, preferably up to about 4.5, more preferably about 4, even more preferably about 3.5, yet more preferably about 3.0, still more preferably about 2.7 mmoles of protons available at pH below about 7.5 per gram of composition.

Suitable sources of protons herein may be organic or inorganic. Suitable organic sources of protons herein are selected from the group consisting of: succinic acid, malonic acid, citric acid, glutaric acid, adipic acid, pimelic acid, suberic acid, azelaic acid, phtalic acid, isophthalic acid, terephthalic acid, hemimellitic acid, trimellitic acid, trimesic acid, mellophanic acid, prehnitic acid, pyromellitic acid, benzenepentacarboxylic acid, and mellitic acid and mixtures thereof. Suitable inorganic sources of protons herein are selected from the group consisting of: hydrogen-sulfuric acid, and dihydrogen-phosphoric acid, and mixtures thereof. Preferably said source of protons herein is selected from the group consisting of citric acid, succinic acid, malonic acid, glutaric acid, and adipic acid and mixtures thereof. More preferably said source of protons herein is selected from the group consisting of citric acid, succinic acid and malonic acid, and mixtures thereof. Most preferably said source of protons herein is citric acid.

In a highly preferred embodiment herein, said source of protons does not include the imido-type peroxy acid present in the compositions according to the present invention.

In a preferred embodiment herein, the composition herein comprises citric acid at concentration of at least about 0.051 grams per gram of composition (resulting in a concentration of at least about 0.80 mmoles of protons available at pH below about 7.5 per gram of composition), preferably at least about 0.083 grams per gram of composition (resulting in a concentration of at least about 1.3 mmoles of protons available at pH below about 7.5 per gram of composition) and more preferably at least about 0.138 grams per gram of composition (resulting in a concentration of at least about 2.2 mmoles of protons available at pH below about 7.5 per gram of composition).

In another preferred embodiment herein, the composition herein comprises succinic acid at concentration of at least about 0.047 grams per gram of composition (resulting in a concentration of at least about 0.80 mmoles of protons available at pH below about 7.5 per gram of composition), preferably at least about 0.076 grams per gram of composition (resulting in a concentration of at least about 1.3 mmoles of protons available at pH below about 7.5 per gram of composition), and more preferably at least about 0.127 grams per gram of composition (resulting in a concentration of at least about 2.2 mmoles of protons available at pH below about 7.5 per gram of composition).

In another preferred embodiment herein, the composition herein comprises malonic acid at concentration of at least about 0.0416 grams per gram of composition (resulting in a concentration of at least about 0.80 mmoles of protons available at pH below about 7.5 per gram of composition), preferably at least about 0.0675 grams per gram of composition (resulting in a concentration of at least 1.3 mmoles of protons available at pH below about 7.5 per gram of composition), and more preferably at least about 0.112 grams per gram of composition (resulting in a concentration of at least about 2.2 mmoles of protons available at pH below about 7.5 per gram of composition).

In another preferred embodiment herein, the composition herein comprises glutaric acid at concentration of at least about 0.0528 grams per gram of composition (resulting in a concentration of at least about 0.80 mmoles of protons available at pH below about 7.5 per gram of composition), preferably at least about 0.0859 grams per gram of composition (resulting in a concentration of at least 1.3 mmoles of protons available at pH below about 7.5 per gram of composition), and more preferably at least about 0.143 grams per gram of composition (resulting in a concentration of at least about 2.2 mmoles of protons available at pH below about 7.5 per gram of composition).

In another preferred embodiment herein, the composition herein comprises adipic acid at concentration of at least about 0.0585 grams per gram of composition (resulting in a concentration of at least about 0.80 mmoles of protons available at pH below about 7.5 per gram of composition), preferably at least about 0.0950 grams per gram of composition (resulting in a concentration of at least 1.3 mmoles of protons available at pH below about 7.5 per gram of composition), and more preferably at least about 0.158 grams per gram of composition (resulting in a concentration of at least about 2.2 mmoles of protons available at pH below about 7.5 per gram of composition).

Surfactants

The compositions of the present invention may comprise a surfactant or a mixture thereof preferably an anionic surfactant or a mixture thereof.

In a particularly preferred embodiment the surfactant is selected from the group consisting of sulfonate anionic surfactants, phosphonate anionic surfactants, phosphate anionic surfactants and carboxylate anionic surfactants, and mixtures thereof.

Typically, the compositions according to the present invention may comprise up to about 3% by weight of the total composition of a surfactant or a mixture thereof, preferably up to about 1% and more preferably up to about 0.5%.

Hydrotropes

The compositions of the present invention may comprise a hydrotrope or a mixture thereof. Hydrotropes are a special class of compounds that are efficient solubilisers, because they can self-associate in aqueous medium influencing the formation of micelles and microemulsions.

Suitable hydrotropes for use herein may include alkylbenzene sulphonates based on toluene, xylene and cumene, polyhydroxy benzene, sodium salts of lower alkanols and derivatives of aromatic acids are generally considered to be effective hydrotropes.

Typically, the compositions according to the present invention may comprise up to about 5% by weight of the total composition of a hydrotrope or a mixture thereof, preferably up to about 1% and more preferably up to about 0.1%.

Chelating Agents

The compositions of the present invention may comprise a chelating agent as a preferred optional ingredient. Suitable chelating agents may be any of those known to those skilled in the art such as the ones selected from the group of phosphonate chelating agents.

The presence of chelating agents contributes to further enhance the chemical stability of the compositions.

Suitable phosphonate chelating agents for use herein may include alkali metal ethane 1-hydroxy diphosphonates (HEDP), alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP). Such phosphonate chelating agents are commercially available from Monsanto under the trade name DEQUEST®.

Particularly preferred chelating agents to be used herein are amino aminotri(methylene phosphonic acid), diethylene triamine penta methylene phosphonate, 1-hydroxy ethane diphosphonate, and mixtures thereof.

Typically, the compositions according to the present invention comprise up to about 5% by weight of the total composition of a chelating agent, or mixtures thereof, preferably from about 0.01% to about 1.5% by weight and more preferably from about 0.01% to about 0.5%.

Radical Scavengers

The compositions of the present invention may comprise a radical scavenger or a mixture thereof.

Suitable radical scavengers for use herein include the well-known substituted mono and dihydroxy benzenes and their analogs, alkyl and aryl carboxylates and mixtures thereof. Preferred such radical scavengers for use herein include di-tert-butyl hydroxy toluene (BHT), hydroquinone, di-tert-butyl hydroquinone, mono-tert-butyl hydroquinone, tert-butyl-hydroxy anysole, benzoic acid, toluic acid, catechol, t-butyl catechol, benzylamine, 1,1,3-tris(2-methyl-4-hydroxy-5-t-butylphenyl) butane, n-propyl-gallate or mixtures thereof and highly preferred is di-tert-butyl hydroxy toluene. Such radical scavengers like N-propyl-gallate may be commercially available from Nipa Laboratories under the trade name Nipanox S1®.

Radical scavengers, when used, are typically present herein in amounts up to about 10% by weight of the total composition and preferably up to about 0.5% by weight.

The presence of radical scavengers may contribute to the chemical stability of the bleaching compositions of the present invention as well as to the safety profile of the compositions of the present invention.

Soil Suspending Polymer

The compositions according to the present invention may further comprise a soil suspending polyamine polymer or mixtures thereof, as optional ingredient. Any soil suspending polyamine polymer known to those skilled in the art may be used herein. Particularly suitable polyamine polymers for use herein are polyalkoxylated polyamines.

Typically, the compositions comprise up to about 10% by weight of the total composition of such a soil suspending polyamine polymer or mixtures thereof, preferably from about 0.1% to about 5% and more preferably from about 0.3% to about 2%.

The compositions herein may also comprise other polymeric soil release agents known to those skilled in the art. Such polymeric soil release agents are characterised by having both hydrophilic segments, to hydrophilize the surface of hydrophobic fibres, such as polyester and nylon, and hydrophobic segments, to deposit upon hydrophobic fibres and remain adhered thereto through completion of washing and rinsing cycles and, thus, serve as an anchor for the hydrophilic segments. This can enable stains occurring subsequent to treatment with the soil release agent to be more easily cleaned in later washing procedures.

If utilized, soil release agents will generally comprise from about 0.01% to about 10.0%, by weight, of the detergent compositions herein, typically from about 0.1% to about 5%, preferably from about 0.2% to about 3.0%.

Brightener

Any optical brighteners, fluorescent whitening agents or other brightening or whitening agents known in the art can be incorporated in the instant compositions when they are designed for fabric treatment or laundering, at levels typically from about 0.05% to about 1.2%, by weight, of the detergent compositions herein.

Minor Ingredients

The composition described herein may also comprise minor ingredients such as pigment or dyes, suds controlling agents, dye transfer inhibitors, suds boosters and perfumes.

Processes of Treating Surfaces

In the present invention, the liquid bleaching composition of the present invention needs to be contacted with the surface to treat.

By “surfaces”, it is meant herein any inanimate surface. These inanimate surfaces include, but are not limited to, hard-surfaces typically found in houses like kitchens, bathrooms, or in car interiors, e.g., tiles, walls, floors, chrome, glass, smooth vinyl, any plastic, plastified wood, table top, sinks, cooker tops, dishes, sanitary fittings such as sinks, showers, shower curtains, wash basins, WCs and the like, as well as fabrics including clothes, curtains, drapes, bed linens, bath linens, table cloths, sleeping bags, tents, upholstered furniture and the like, and carpets. Inanimate surfaces also include household appliances including, but not limited to, refrigerators, freezers, washing machines, automatic dryers, ovens, microwave ovens, dishwashers and so on.

By “treating a surface”, it is meant herein bleaching and/or disinfecting said surfaces as the compositions of the present invention comprise a bleach and optionally cleaning as said compositions may comprise a surfactant or any other conventional cleaning agents.

Thus, the present invention also encompasses a process of treating, especially bleaching a fabric, as the inanimate surface. In such a process a composition according to the present invention is contacted with the fabrics to be treated.

The liquid bleaching compositions herein are preferably used as so-called liquid bleach additive compositions suitable for use in conjunction with a conventional laundry detergent, and in particular with particulate laundry detergents, to treat (stained) fabrics. The terms “additive” or “through-the-wash (bleaching) composition” refer to compositions that are preferably employed in the specific process of treating, preferably bleaching, fabrics as encompassed by the present invention.

Indeed, additive compositions are added together with a conventional laundry detergent (preferably particulate laundry detergent) into a washing machine and are active in the same wash-cycle.

The present invention encompasses a process of treating fabrics which comprises the steps of forming an aqueous bath comprising water, a conventional laundry detergent, preferably a granular laundry detergent, and a liquid bleaching composition according to the present invention, and subsequently contacting said fabrics with said aqueous bath.

Typically, the liquid bleaching compositions according to the present invention are dosed at minimum about 50 grams per wash-load, preferably of from about 55 grams to about 170 grams, more preferably about 60 grams to about 110 grams.

The process of treating, preferably bleaching, fabrics according to the present invention delivers effective whiteness performance as well as effective stain removal performance.

The bleaching performance of the liquid bleaching compositions herein may be evaluated by the following test methods on various types of bleachable stains:

A suitable test method for evaluating the bleaching performance on a soiled fabric under additive-conditions (also referred herein as “through-the-wash” conditions) is the following: A liquid bleaching composition is used in the wash-cycle of a conventional washing machine. The liquid bleaching composition is added together with a conventional particulate laundry detergent (such as DASH® powder, TIDE®, ARIEL tablets®, ARIEL® powder). The liquid bleaching composition is dosed at about 50 to about 100 ml per wash load and the conventional laundry detergent is dosed at about 110 grams per wash load for granules and about 2 tabs per wash load for tablets (recommended dosages). In the washing machine the soiled fabrics are washed according to the standard procedure of the washing machine at a temperature of from about 30° to about 70° C. for about 10 to about 100 minutes and then rinsed. Reference composition(s) in the comparative test undergo the same treatment. Soiled fabrics/swatches with for example tea, coffee and the like may be commercially available from E.M.C. Co. Inc.

A visual grading may be used to assign difference in panel units (psu) in a range from 0 to 4, wherein 0 means no noticeable difference in bleaching performance between a liquid bleaching composition according to the present invention and a reference composition and 4 means a noticeable difference in bleaching performance between a liquid bleaching composition according to the present invention and a reference composition.

The process of treating fabrics herein comprises the steps of forming an aqueous bath comprising water, a conventional laundry detergent and a liquid bleaching composition, as described herein, subsequently contacting said fabrics with said aqueous bath.

By “conventional laundry detergent” it is meant herein, a laundry detergent composition currently available on the market. Preferably, said conventional laundry detergent comprises at least one surfactant. Said laundry detergent compositions may be formulated as particulates (including powders, pearls, granules, tablets and the like), liquids (liquids, gels, and the like) as well as detergent forms based on water-soluble or water-permeable pouches comprising liquids and/or particulates (such as liquid-tabs). Suitable particulate laundry detergent compositions are for example DASH powder®, ARIEL tablets®, ARIEL powder® and other products sold under the trade names ARIEL® or TIDE®.

In a preferred embodiment herein, the conventional laundry detergent is a conventional particulate laundry detergent more preferably a conventional powder, pearl, granule or tablet laundry detergent.

In a preferred embodiment according to the present invention, the conventional laundry detergent as described herein and, the liquid bleaching composition herein are dissolved or dispersed, preferably substantially dissolved or dispersed, in the aqueous bath formed in the process according to the present invention. By “substantially dissolved or dispersed” it is meant herein, that at least about 50%, preferably at least about 80%, more preferably at least about 90%, even more preferably at least about 95%, still more preferably at least about 98%, and most preferably at least about 99%, of said conventional laundry detergent and/or said liquid bleaching composition are dissolved or dispersed in the aqueous bath formed in the process according to the present invention.

The liquid bleaching composition and the conventional detergent composition may be delivered into the washing machine either by charging the dispenser drawer of the washing machine with one or both of the detergents or by directly charging the drum of the washing machine with one or both of the detergents. More preferably the liquid bleaching composition is directly placed into the drum of the washing machine, preferably using a dosing device, such as a dosing ball (such as the Vizirette®). Even more preferably the liquid bleaching composition and the conventional detergent composition are both placed into the drum of the washing machine, preferably using suitable dosing devices such as dosing balls, dosing nets etc. The liquid bleaching composition is preferably delivered to the main wash cycle of the washing machine before, but more preferably at the same time as the conventional detergent composition.

During the processes according to the present invention the liquid bleaching compositions herein are typically used in diluted form. By “in diluted form”, it is meant herein that the liquid bleaching compositions according to the present invention may be diluted by the user, preferably with water. The dilution occurs in a washing machine. Said compositions can be diluted up to about 500 times, preferably from about 5 to about 200 times and more preferably from about 10 to about 80 times.

The present invention also encompasses so-called ‘spotter’ or ‘pretreater’ compositions that are applied, mostly undiluted, onto fabrics prior to washing or rinsing the fabrics and left to act thereon for an effective amount of time. Furthermore, the present invention encompasses so-called ‘soakers’ or ‘rinse-added’ compositions, which are contacted, mostly in diluted form, with fabrics prior or during rinsing of fabrics with water.

Furthermore, the liquid bleaching compositions herein may be used in so-called commercial laundry applications. Indeed, liquid bleaching compositions herein may be used as the sole active composition in a large scale commercial bleaching process, or in combination with a detergent as a bleach booster composition (bleach additive function), or added prior or after the main detergent in a commercial laundry cleaning operation in a commercial laundry washing machine or a tunnel laundry washing machine.

In another embodiment the present invention also encompasses a process of treating a hard-surface, as the inanimate surface. In such a process a composition, as defined herein, is contacted with the hard-surfaces to be treated. Thus, the present invention also encompasses a process of treating a hard-surface with a composition, as defined herein, wherein said process comprises the step of applying said composition to said hard-surface, preferably only soiled portions thereof, and optionally rinsing said hard-surface.

In the process of treating hard-surfaces according to the present invention the composition, as defined herein, may be applied to the surface to be treated in its neat form or in its diluted form typically up to about 200 times their weight of water, preferably into about 80 to about 2 times their weight of water, and more preferably about 60 to about 2 times.

When used as hard surfaces bleaching/disinfecting compositions the compositions of the present invention are easy to rinse and provide good shine characteristics on the treated surfaces.

By “hard-surfaces”, it is understood any hard-surfaces as mentioned herein before as well as dishes.

Packaging Form of the Liquid Compositions:

Depending on the end-use envisioned, the compositions herein can be packaged in a variety of containers including conventional bottles, bottles equipped with roll-on, sponge, brusher or sprayers.

The invention is further illustrated by the following examples.

Experimental Data

The following examples will further illustrate the present invention. The compositions are made by combining the listed ingredients in the listed proportions (weight % unless otherwise specified). Furthermore, the compositions comprise water and minors up to 100%.

The following compositions were tested for their physical stability:

| | Compositions (% weight) | | | | |
|---|---|---|---|---|---|
| | A | B | C | D | E |
| PAP | 3.0 | 3.0 | 3.0 | 3.0 | 3.0 |
| HEDP | 0.2 | 0.2 | 0.2 | 0.2 | 0.2 |
| RHEOZAN ® | 0.6 | 0.0 | 0.0 | 0.0 | 0.0 |
| Kelzan T ® | 0.0 | 0.6 | 0.6 | 0.6 | 0.6 |
| AE3S | 0.0 | 0.0 | 0.0 | 3.0 | 3.0 |
| Citric acid | 8.3 | 8.3 | 0.0 | 0.0 | 8.3 |
| pH (trimmed with NaOH) | 1.5 | 1.5 | 3.5 | 3.5 | 1.5 |
| Stability at 35° C. | | | | | |
| settling of PAP particles: | none | after | after | after | after |
| | | 1 day | 1 day | 8 days | 2 days |

Composition A is a bleaching composition according to the present invention and compositions B-E are comparative examples. Compositions A-E were stored at 35° C. and the physical stability upon storage of the solid imido-type peroxy acid particles (PAP)-containing compositions was evaluated by visually assessing the distribution of the PAP particles in the compositions. The time until physical instability, manifested by the settling of imido-type peroxy acid particles (non-homogenous distribution) was recoded. The test was terminated after 8 weeks. Composition A, comprising succinoglycan gum, showed no settling of PAP particles after 8 weeks of storage, whereas compositions comprising xanthan gum (B-E) could not be stabilised for more than 8 days. Indeed, xanthan gum-containing compositions needed to be stabilised with an alkyl ethoxylated sulfate surfactant to be stable for more than one day (Compositions D+E).

### EXAMPLES

The following examples will further illustrate the present invention. The compositions are made by combining the listed ingredients in the listed proportions (weight % unless otherwise specified). Furthermore, the compositions comprise water and minors up to 100%. The following Examples are meant to further exemplify compositions according to the present invention but are not necessarily used to limit or otherwise define the scope of the present invention.

| | Compositions (% weight) | | | | |
|---|---|---|---|---|---|
| | I | II | III | IV | V |
| PAP | 3.0 | 2.0 | 4.0 | 1.0 | 5.0 |
| RHEOZAN ® | 0.3 | 0.25 | 0.6 | 0.3 | 0.2 |
| HEDP | 0.2 | 0.1 | 0.2 | 0.1 | 0.2 |
| Citric acid | 8.3 | 0.0 | 0.0 | 9.2 | 4.0 |
| Succinic acid | 0.0 | 7.6 | 0.0 | 0.0 | 5.0 |
| Malonic acid | 0.0 | 0.0 | 6.8 | 0.0 | 0.0 |
| Glutaric acid | 0.0 | 0.0 | 0.0 | 0.0 | 0.0 |
| Adipic acid | 0.0 | 0.0 | 0.0 | 0.0 | 0.0 |
| Witconate NAS 8 ® | 0.0 | 1.0 | 0.0 | 1.0 | 0.0 |
| NaXS | 0.0 | 0.0 | 0.5 | 0.5 | 0.5 |
| pH (trimmed with NaOH) | 1.9 | 2.5 | 2.5 | 2.5 | 1.9 |

| | Compositions (% weight) | | | | |
|---|---|---|---|---|---|
| | VI | VII | VIII | IX | X |
| PAP | 3.0 | 5.0 | 4.0 | 1.0 | 3.0 |
| RHEOZAN ® | 0.5 | 0.3 | 0.6 | 0.3 | 0.9 |
| HEDP | 0.2 | 0.2 | 0.2 | 0.1 | 0.2 |
| Citric acid | 5.1 | 13.8 | 0.0 | 8.0 | 11.2 |
| Succinic acid | 0.0 | 0.0 | 12.8 | 5.0 | 0.0 |
| Malonic acid | 0.0 | 0.0 | 0.0 | 0.0 | 0.0 |
| Glutaric acid | 0.0 | 0.0 | 0.0 | 0.0 | 0.0 |
| Adipic acid | 0.0 | 0.0 | 0.0 | 0.0 | 0.0 |
| Witconate NAS 8 ® | 0.5 | 0.0 | 0.0 | 1.0 | 0.0 |
| NaXS | 0.0 | 0.5 | 0.5 | 0.5 | 0.5 |
| pH (trimmed with NaOH) | 2.0 | 1.5 | 2.1 | 1.9 | 3.0 |

| | Compositions (% weight) | | | | |
|---|---|---|---|---|---|
| | XI | XII | XIII | XIV | XV |
| PAP | 3.0 | 2.0 | 1.0 | 2.0 | 2.0 |
| RHEOZAN ® | 0.3 | 0.5 | 0.6 | 0.9 | 0.2 |
| HEDP | 0.2 | 0.2 | 0.2 | 0.1 | 0.2 |
| Citric acid | 8.3 | 8.3 | 8.3 | 0.0 | 0.0 |
| Succinic acid | 0.0 | 0.0 | 0.0 | 0.0 | 0.0 |
| Malonic acid | 0.0 | 0.0 | 0.0 | 0.0 | 0.0 |
| Glutaric acid | 0.0 | 0.0 | 0.0 | 0.0 | 8.6 |
| Adipic acid | 0.0 | 0.0 | 0.0 | 9.5 | 0.0 |
| Witconate NAS 8 ® | 0.0 | 0.0 | 0.0 | 0.0 | 0.5 |
| NaXS | 0.5 | 0.5 | 0.5 | 0.5 | 0.0 |
| pH (trimmed with NaOH) | 1.9 | 1.9 | 1.9 | 2.9 | 3.0 |

RHEOZAN ® is succinoglycan gum available from Rhodia
Witconate NAS 8 ® is an alkyl sulphonate available from Witco AS
HEDP is ethane 1-hydroxy diphosphonate commercially available from Monsanto under the DEQUEST ® series.
PAP is phthalimido peroxy hexanoic acid available from Ausimont under the tradename Eureco ®.
NaXS is sodium xylene sulfonate, available from Rhodia under the trade name of Eltesol SX 33 ®.
Kelzan T ® is Xanthan gum commercially available from CPCelco.
AE3S is a sodium C_{12/14} alkyl-3-ethoxy sulfate.

All documents cited in the Detailed Description of the Invention are, in relevant part, incorporated herein by reference; the citation of any document is not to be construed as an admission that it is prior art with respect to the present invention. To the extend that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid bleaching composition, having a pH up to about 3, and compromising an imido-type peroxy acid and a succinoglycan gum.

2. A liquid bleaching composition according to claim 1, wherein said imido-type peroxy acid is a solid, substantially water insoluble pre-formed imido-type peroxy acid.

3. A liquid bleaching composition according to claim 1, wherein said imido-type peroxy acid has the general formula: 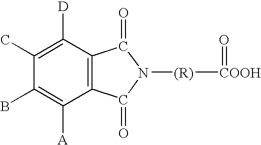
wherein R is C1-20 alkyl group and where A, B, C and D are independently either hydrogen or substituent groups individually selected from the group consisting of alkyl, hydroxyl, nitro, halogen, amine, ammonium, cyanide, carboxylic, sulphate, sulphonate, aldehydes or mixtures thereof.

4. A liquid bleaching composition according to claim 1, wherein said imido-type peroxy acid has general formula: 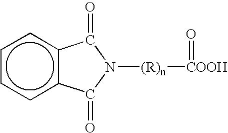
wherein R is about C₁₋₄ alkyl and n is an integer of from about 1 to about 5.

5. A liquid bleaching composition according to claim 1, wherein said imido-type peroxy acid is an imido-type peroxy alkanoic acid.

6. A liquid bleaching composition according to claim 1, wherein said imido-type peroxy acid is selected from the group consisting of: ε-phthalimido peroxy hexanoic acid; phthalimido peroxy heptanoic acid; phthalimido peroxy octanoic acid; phthalimido peroxy nonanoic acid; and Phthalimido peroxy decanoic acid; and mixtures thereof and most preferably ε-phthalimido peroxy hexanoic acid.

7. A liquid bleaching composition, having a pH up to about 3, and compromising ε-phthalimido peroxy hexanoic acid and a succinoglycan gum.

8. A liquid bleaching composition according to claim 1, wherein said composition comprises of from about 0.1% to about 10% by weight of the total composition of said imido-type peroxy acid.

9. A liquid bleaching composition according to claim 1, wherein said composition comprises of from about 10% to about 40% by weight of the total composition of said imido-type peroxy acid.

10. A liquid bleaching composition according to claim 1, having a pH between about 0.5 and about 3.

11. A liquid bleaching composition according to claim 1, wherein said composition comprises of from about 0.01% to about 10% by weight of the total composition of said succinoglycan gum.

12. A liquid bleaching composition according to claim 1, wherein said composition is free of a cross-linked polycarboxylate polymer and/or a hydrophobically modified polycarboxylate polymer and/or a nonionic surfactant.

13. A liquid bleaching composition according to claim 1, wherein said composition additionally comprises a source of protons.

14. A liquid bleaching composition according to claim 12, wherein said source of protons is an organic source of protons selected from the group consisting of: succinic acid, malonic acid, citric acid, glutaric acid, adipic acid, pimelic acid, suberic acid, azelaic acid, phtalic acid, isophthalic acid, terephthalic acid, hemimellitic acid, trimellitic acid, trimesic acid, mellophanic acid, prehnitic acid, pyromellitic acid, benzenepentacarboxylic acid, and mellitic acid and mixtures thereof.

15. A liquid bleaching composition according to claim 12, wherein said source of protons is selected from the group consisting of citric acid, succinic acid, malonic acid, glutaric acid, and adipic acid and mixtures thereof.

16. A liquid bleaching composition, having a pH up to about 3, and compromising ε-phthalimido peroxy hexanoic acid, a succinoglycan gum and source of protons selected from the group consisting of citric acid, succinic acid, malonic acid, glutaric acid, and adipic acid and mixtures thereof.

17. A liquid bleaching composition according to claim 12, wherein said source of protons is selected from the group consisting of: citric acid present at a level of at least about 5.1%; succinic acid present at a level of at least about 4.7%; malonic acid present at a level of at least about 4.2%; glutaric acid present at a level of at least about 5.3%; and adipic acid present at a level of at least about 5.9%; and mixtures thereof.

18. A process of bleaching a surface, preferably a fabric, with a liquid bleaching composition according to claim 1.

19. A method of improving immediate physical stability benefit and/or physical stability upon storage of a liquid bleaching composition, having a pH of up to about 3, and comprising an imido-type peroxy acid by adding a succinoglycan gum to said composition.
